(19) United States
(12) Patent Application Publication
(10) Pub. No.: US 2026/0114453 A1
(43) Pub. Date: Apr. 30, 2026

(54) DIAZOTROPHS AND ARBUSCULAR MYCORRHIZAL FUNGI MIXTURES

(71) Applicant: Valent BioSciences LLC, Libertyville, IL (US)

(72) Inventors: April McIntyre, Libertyville, IL (US); Charles Cowden, Libertyville, IL (US); John Allar, Libertyville, IL (US); Dierdra Daniels, Libertyville, IL (US); Daniela Floss, Libertyville, IL (US); Mark Beach, Kenosha, WI (US)

(21) Appl. No.: 19/372,689

(22) Filed: Oct. 29, 2025

Related U.S. Application Data
(60) Provisional application No. 63/713,635, filed on Oct. 30, 2024.

(51) Int. Cl. A01N 63/25; A01N 25/08; A01N 63/30; A01P 21/00

(52) U.S. Cl. CPC A01N 63/25; A01N 25/08; A01N 63/30; A01P 21/00

(57) ABSTRACT

The present invention is directed to agricultural mixtures comprising one or more diazotrophs and one or more arbuscular mycorrhizal fungi. The present invention is further directed to compositions comprising one or more diazotrophs, one or more arbuscular mycorrhizal fungi and one or more agriculturally acceptable carriers. The present invention is further directed to methods of improving plant growth, yield and/or quality comprising applying an effective amount of a mixture or composition of the present invention to a plant, plant propagation material or an area where a plant will grow.

### FIELD OF THE INVENTION

The present invention is directed to agricultural mixtures comprising one or more diazotrophs and one or more arbuscular mycorrhizal fungi.

The present invention is further directed to compositions comprising one or more diazotrophs, one or more arbuscular mycorrhizal fungi and one or more agriculturally acceptable carriers.

The present invention is further directed to methods of improving plant growth, yield and/or quality comprising applying an effective amount of a mixture or composition of the present invention to a plant, plant propagation material or an area where a plant will grow.

### BACKGROUND OF THE INVENTION

Huge amounts of water and fertilizer are utilized across agricultural and landscaping practices. These practices, although readily accepted and necessary, lead to an exacerbation of water quantity and quality issues across the world. Further, standard manufacturing processes of nitrogen (“N”) fertilizers are fossil fuel-based and energy-intensive. N fertilizers are commonly manufactured utilizing ammonia produced by the Haber-Bosch process, utilizing methane and nitrogen gas. Nearly 100 million tons of various N fertilizers are manufactured annually on a global basis, making them one of the largest industrial chemicals by volume.

Crop productivity relies heavily on synthetic N fertilizers because of the limited natural nitrogen supply in agricultural soils. The addition of chemical N fertilizers to cropping systems is important to achieving crops yields required to feed the world's population. However, synthetic N fertilizers are very unstable in soils, and more than half of the nitrogen added to the soil is lost to leaching and evolution of nitrous oxide, a potent greenhouse gas.

Mycorrhizae are symbiotic associations between fungi (i.e. mycorrhizal fungi) and the roots of plants. Mycorrhizal fungi are associated with greater than 90% of all land plants including crops, grasses and trees. Mycorrhizal fungi provide many important benefits to plants including enhanced absorption of water and nutrients from the soil, increased drought resistance, increased pathogen resistance and protection, enhanced plant health and vigor, minimized effects of external stress, and enhanced seedling growth. In turn, the external application of Mycorrhizal fungi to plants can lead to less irrigation and fertilization, which saves water and reduces the amount of chemicals, such as nitrates and phosphorus, and almost all the micronutrients.

Current Mycorrhizae formulations include those developed by Mycorrhizal Applications. These formulations aid in increased water use and mineral uptake efficiency for plants. However, these formulations are not sufficient to supplement nitrogen needs by the plant.

Thus, there is a need in the art for improved nitrogen use efficiency by plants that can be maintained in an environmentally sustainable manner.

### SUMMARY OF THE INVENTION

The present invention is directed to agricultural mixtures comprising one or more diazotrophs and one or more arbuscular mycorrhizal fungi.

The present invention is further directed to compositions comprising one or more diazotrophs, one or more arbuscular mycorrhizal fungi and one or more agriculturally acceptable carriers.

The present invention is further directed to methods of improving plant growth, yield and/or quality comprising applying an effective amount of a mixture or composition of the present invention to a plant, plant propagation material or an area where a plant will grow.

### DETAILED DESCRIPTION OF THE INVENTION

The Applicant has unexpectedly discovered that a mixture of one or more diazotrophs and one or more arbuscular mycorrhizal fungi increase nitrogen uptake and use by plants.

In one embodiment, the present invention is directed to an agricultural mixture comprising one or more diazotrophs and one or more arbuscular mycorrhizal fungi.

In a preferred embodiment, the one or more diazotrophs are spore-associated bacteria. In a more preferred embodiment, the one or more spore-associated bacteria are Paenibacillus spp.

In an even more preferred embodiment, the one or more Paenibacillus spp. are selected from the group consisting of Paenibacillus peoriae, Paenibacillus polymxya, Paenibacillus sonchi, and Paenibacillus azotifgiens. In a yet even more preferred embodiment, the one or more Paenibacillus spp. are selected from the group consisting of Paenibacillus peoriae strain VBTS 2584 and Paenibacillus polymxya strain VBTS 2630.

Paenibacillus peoriae strain VBTS 2584 was deposited with the American Type Culture Collection in Manassas, Virginia on Nov. 25, 2024 having accession number PTA-127852.

Paenibacillus polymxya strain VBTS 2630 was deposited with the American Type Culture Collection in Manassas, Virginia on Nov. 25, 2024 having accession number PTA-127851.

In another preferred embodiment, the one or more arbuscular mycorrhizal fungi are selected from the group consisting of Glomus spp., Claroideoglomus spp., Funneliformis spp., Rhizophagus spp., Rhizopogon spp, Pisolithus spp, and Scleroderma spp. In a more preferred embodiment, the one or more arbuscular mycorrhizal fungi are selected from the group consisting of Rhizophagus irregularis, Rhizophagus intraradices, Claroideoglomus etunicatum, Claroideoglomus claroideum, Funneliformis mosseae, Rhizopogon villosulus, Rhizopogon luteolus, Rhizopogon amylopogon, Rhizopogon fulvigleba, Pisolithus tinctorius, Scleroderma cepa, and Scleroderma citrinum.

Rhizophagus intraradices, Funnelformis mosseae, Claroideoglomus claroideum, and Claroideoglomus etunicatum are available from Mycorrhizal Applications in MycoApply® Endo containing 33.1 propagules/gram of each and clay as a carrier.

Rhizophagus intraradices (33.1 propagules per gram), Funnelformis mosseae (33.1 propagules per gram), Claroideoglomus claroideum (33.1 propagules per gram), Claroideoglomus etunicatum (33.1 propagules per gram), Rhizopogon villosulus (11,000 propagules per gram), Pisolithus tinctorius (220,509 propagules per gram), and Scleroderma cepa (11,000 propagules per gram) are available from Mycorrhizal Applications in MycoApply® Endo/Ecto which also contains a clay carrier.

Glomus intraradices (71.7 propagules per gram), Glomus mosseae (71.7 propagules per gram), Glomus aggregatum (71.7 propagules per gram) and Glomus etunicatum (71.7 propagules per gram) are available from Mycorrhizal Applications in MycoApply® Ultrafine Endo which also contains a clay carrier.

Glomus intraradices (71.7 propagules per gram), Glomus mosseae (71.7 propagules per gram), Glomus aggregatum (71.7 propagules per gram), Glomus etunicatum (71.7 propagules per gram), Rhizopogon villosulus (2,750 propagules per gram), Rhizopogon luteolus (2,750 propagules per gram), Rhizopogon amylopogon (2,750 propagules per gram), Rhizopogon fulvigleba (2,750 propagules per gram), Pisolithus tinctorius (220,509 propagules per gram), Scleroderma cepa (5,500 propagules per gram), and Scleroderma citrinum (5,500 propagules per gram) are available from Mycorrhizal Applications in MycoApply® Ultrafine Endo/Ecto which also contains a clay carrier.

Rhizophagus irregularis, Rhizophagus intraradices and Glomus intraradices each refer to the same organism.

Claroideoglomus etunicatum and Glomus etunicatum refer to the same organism.

Funneliformis mosseae and Glomus mosseae refer to the same organism.

In another embodiment, the present invention is directed to compositions comprising one or more diazotrophs and one or more arbuscular mycorrhizal fungi and an agriculturally acceptable carrier.

Agriculturally acceptable carriers suitable for use in the present invention include, but are not limited to, water.

In a preferred embodiment, compositions of the present invention may further comprise one or more excipients.

Excipients suitable for use in the present invention include but are not limited to, surfactants, binders, wetting agents, preservatives, solubilizers, stabilizers, binders, film-formers, anti-foaming agents, dispersants, spreaders, stickers, pH regulators, humectants, dyes, ultra-violet light protectants, or other components which facilitate production, storage stability, product handling application and biological efficacy.

Compositions of the present invention may be in the form of a liquid or a solid. In a preferred embodiment, the compositions of the present invention are in the form of a suspension, a granule, a powder and a seed coating. In a preferred embodiment, the composition of the present invention is a granule. In a more preferred embodiment, the granule comprises clay.

In another embodiment, the present invention is directed to methods of improving plant growth comprising applying an effective amount of a mixture or a composition of the present invention to a plant, plant propagation.

In another embodiment, the present invention is directed to methods of improving plant yield comprising applying an effective amount of a mixture or a composition of the present invention to a plant, plant propagation.

In another embodiment, the present invention is directed to methods of improving plant quality comprising applying an effective amount of a mixture or a composition of the present invention to a plant, plant propagation.

In another embodiment, the present invention is directed to methods of increasing nitrogen uptake by a plant comprising applying an effective amount of a mixture or a composition of the present invention to a plant, plant propagation.

In another embodiment, the present invention is directed to methods of increasing ammonia concentration of soil comprising applying an effective amount of a mixture or a composition of the present invention to the soil.

Compositions of the present invention may be applied to any plant or plant propagation material thereof that may benefit from improved growth, yield and/or quality including agricultural crops, annual grasses, trees, shrubs, ornamental flowers and the like. Compositions of the present invention may further be applied to any area where a plant will grow including soil, a plant root zone and a furrow.

As used herein, the term “plant propagation material” refers to seeds and seedlings of all kinds (fruit, tubers, and grains), clonal and micro propagated plants, and the like.

As used herein, the term “soil” refers to a medium in which a plant is capable of growing.

As used herein, “improving” means that the plant has more of the specific quality than the plant would have had it if it had not been treated by methods of the present invention.

As used herein, “effective amount” refers to the amount of the mixture of the present invention that will improve plant growth, yield, and/or quality. The “effective amount” will vary depending on the concentrations of the components of the mixture, the plant species or variety being treated, the result desired, and the life stage of the plants, among other factors. Thus, it is not always possible to specify an exact “effective amount.” However, an appropriate “effective amount” in any individual case may be determined by one of ordinary skill in the art.

As used herein, “improving” means that the plant has more of the quality than the plant would have had it if it had not been treated by methods of the present invention.

As used herein, “yield” refers to any measurable mass of the plant including, but not limited to, total biomass of the plant and the mass of commercially viable products of the plant.

As used herein, “plant quality” refers to measurable plant qualities that are desirable by the consumer including, but not limited to, size, texture, color, firmness, aroma, and flavor.

As used herein, all numerical values relating to amounts, weight percentages and the like are defined as “about” or “approximately” each particular value, plus or minus 10%. For example, the phrase “at least 5.0% by weight” is to be understood as “at least 4.5% to 5.5% by weight.” Therefore, amounts within 10% of the claimed values are encompassed by the scope of the claims.

As used herein % w/w denotes weight by total weight of the composition. All concentrations listed herein are in % w/w unless otherwise described.

The articles “a,” “an” and “the” are intended to include the plural as well as the singular, unless the context clearly indicates otherwise.

The terms “composition” and “formulation” are used interchangeably throughout the application.

As used herein the term “diazotroph” or “diazotrophs” refers to bacteria and archaea that are capable of converting atmospheric nitrogen to ammonia. Nitrogen exists in the atmosphere as dinitrogen (i.e. N₂). Ammonia also known as azane has molecular formula NH₃.

As used herein the term “spore-associated bacteria” refers to bacteria that spend part of their life on or inside a fungal spore.

In another embodiment, the plant is a monocotyledonous plant or a dicotyledonous plant. In a preferred embodiment the plant is selected from the group consisting of root, corm and tuber vegetable plants, bulb vegetable plants, leafy non-brassica vegetable plants, leafy brassica vegetable plants, succulent or dried legume plants, fruiting vegetable plants, cucurbit vegetable plants, citrus fruit plants, pome fruit plants, stone fruit plants, berry and small fruit plants, tree nut plants, cereal crops, forage and fodder grasses and hay, non-grass animal feed plants, herb plants, spice plants, flower plants, bedding plants, ornamental flower plants, artichoke, asparagus, tropical fruit plants, hops, malanga, peanut, pomegranate plants, oil seed vegetable plants, tobacco plants, turf grass and watercress plant.

In a preferred embodiment, the root, corm and tuber vegetable plants are selected from the group consisting of arracacha, arrowroot, Chinese artichoke, Jerusalem artichoke, garden beet, sugar beet, edible burdock, edible canna, carrot, bitter cassava, sweet cassava, celeriac, root chayote, turnip-rooted chervil, chicory, chufa, dasheen (taro), ginger, ginseng, horseradish, leren, turnip-rooted parsley, parsnip, potato, radish, oriental radish, rutabaga, salsify, black salsify, Spanish salsify, skirret, sweet potato, tanier, turmeric, turnip, yam bean, true yam, and cultivars, varieties and hybrids thereof.

In another preferred embodiment, the bulb vegetable plants are selected from the group consisting of fresh chive leaves, fresh Chinese chive leaves, bulb daylily, elegans hosta, bulb fritillaria, fritillaria leaves, bulb garlic, great-headed bulb garlic, serpent bulb garlic, kurrat, lady's leek, leek, wild leek, bulb lily, Beltsville bunching onion, bulb onion, Chinese bulb onion, fresh onion, green onion, macrostem onion, pearl onion, potato bulb onion, potato bulb, tree onion tops, Welsh onion tops, bulb shallot, fresh shallot leaves, and cultivars, varieties and hybrids thereof.

In a further embodiment, the leafy non-brassica vegetable plants are selected from the group consisting of Chinese spinach Amaranth, leafy Amaranth, arugula (roquette), cardoon, celery, Chinese celery, celtuce, chervil, Chinese spinach, edible-leaved chrysanthemum, garland chrysanthemum, corn salad, garden cress, upland cress, dandelion, dandelion leaves, sorrels (dock), endive (escarole), Florence fennel, head lettuce, leaf lettuce, orach, parsley, garden purslane, winter purslane, radicchio (red chicory), rhubarb, spinach, New Zealand spinach, vine spinach, Swiss chard, Tampala, and cultivars, varieties and hybrids thereof.

In another embodiment, the leafy brassica vegetable plants are selected from the group consisting of broccoli, Chinese broccoli (gai lon), broccoli rabe (rapini), Brussels sprouts, cabbage, Chinese cabbage (bok choy), Chinese napa cabbage, Chinese mustard cabbage (gai choy), cauliflower, cavolo broccoli, collards, kale, kohlrabi, mizuna, mustard greens, mustard spinach, rape greens, turnip greens and cultivars, varieties and hybrids thereof. In yet another embodiment, the succulent or dried vegetable legumes are selected from the group consisting of Lupinus beans, Phaseolus beans, Vigna beans, broad beans (fava), chickpea (garbanzo), guar, jackbean, lablab bean, lentil, Pisum peas, pigeon pea, soybean, immature seed soybean, sword bean, peanut, and cultivars, varieties and hybrids thereof. In a preferred embodiment, the Lupinus beans include grain lupin, sweet lupin, white lupin, white sweet lupin, and hybrids thereof. In another preferred embodiment, the Phaseolus beans include field bean, kidney bean, lima bean, navy bean, pinto bean, runner bean, snap bean, tepary bean, wax bean, and hybrids thereof. In yet another preferred embodiment, the Vigna beans include adzuki bean, asparagus bean, blackeyed bean, catjang, Chinese longbean, cowpea, Crowder pea, moth bean, mung bean, rice bean, southern pea, urd bean, yardlong bean, and hybrids thereof. In another embodiment, the Pisum peas include dwarf pea, edible-podded pea, English pea, field pea, garden pea, green pea, snow pea, sugar snap pea, and hybrids thereof. In a preferred embodiment, the dried vegetable legume is soybean. In a more preferred embodiment, the dried vegetable legume is genetically modified soybean.

In a further embodiment, the fruiting vegetable plants are selected from the group consisting of bush tomato, cocona, currant tomato, garden huckleberry, goji berry, groundcherry, martynia, naranjilla, okra, pea eggplant, pepino, bell peppers, non-bell peppers, roselle, eggplant, scarlet eggplant, African eggplant, sunberry, tomatillo, tomato, tree tomato, and cultivars, varieties and hybrids thereof. In a preferred embodiment, the peppers include bell peppers, chili pepper, cooking pepper, pimento, sweet peppers, and hybrids thereof.

In an embodiment, the cucurbit vegetable plants are selected from the group consisting of Chayote, Chayote fruit, waxgourd (Chinese preserving melon), citron melon, cucumber, gherkin, edible gourds, Momordica species, muskmelons, pumpkins, summer squashes, winter squashes, watermelon, and cultivars, varieties and hybrids thereof. In a preferred embodiment, edible gourds include hyotan, cucuzza, hechima, Chinese okra, and hybrids thereof. In another preferred embodiment, the Momordica vegetables include balsam apple, balsam pear, bittermelon, Chinese cucumber, and hybrids thereof. In another preferred embodiment, the muskmelon include true cantaloupe, cantaloupe, casaba, crenshaw melon, golden pershaw melon, honeydew melon, honey balls, mango melon, Persian melon, pineapple melon, Santa Claus melon, snake melon, and hybrids thereof. In yet another preferred embodiment, the summer squash include crookneck squash, scallop squash, straightneck squash, vegetable marrow, zucchini, and hybrids thereof. In a further preferred embodiment, the winter squash includes butternut squash, calabaza, hubbard squash, acorn squash, spaghetti squash, and hybrids thereof.

In another embodiment, the citrus fruit plants are selected from the group consisting of limes, calamondin, citron, grapefruit, Japanese summer grapefruit, kumquat, lemons, Mediterranean mandarin, sour orange, sweet orange, pummelo, Satsuma mandarin, tachibana orange, tangelo, mandarin tangerine, tangor, trifoliate orange, uniq fruit, and cultivars, varieties and hybrids thereof. In a preferred embodiment, the limes are selected from the group consisting of Australian desert lime, Australian finger lime, Australian round lime, Brown River finger lime, mount white lime, New Guinea wild lime, sweet lime, Russell River lime, Tahiti lime, and hybrids thereof.

In an embodiment, the pome fruit plants are selected from the group consisting of apple, azarole, crabapple, loquat, mayhaw, medlar, pear, Asian pear, quince, Chinese quince, Japanese quince, tejocote, and cultivars, varieties and hybrids thereof.

In another embodiment, the stone fruit plants are selected from the group consisting of apricot, sweet cherry, tart cherry, nectarine, peach, plum, Chicksaw plum, Damson plum, Japanese plum, plumcot, fresh prune, and cultivars, varieties and hybrids thereof.

In a further embodiment, the berries and small fruit plants are selected from the group consisting of Amur river grape, aronia berry, bayberry, bearberry, bilberry, blackberry, blueberry, lowbush blueberry, highbush blueberry, buffalo currant, buffaloberry, che, Chilean guava, chokecherry, cloudberry, cranberry, highbush cranberry, black currant, red currant, elderberry, European barberry, gooseberry, grape, edible honeysuckle, huckleberry, jostaberry, Juneberry (Saskatoon berry), lingonberry, maypop, mountain pepper berries, mulberry, muntries, native currant, partridgeberry, phalsa, pincherry, black raspberry, red raspberry, riberry, salal, sea buckthorn, serviceberry, strawberry, wild raspberry, and cultivars, varieties and hybrids thereof.

In a preferred embodiment, the blackberries include Andean blackberry, arctic blackberry, bingleberry, black satin berry, boysenberry, brombeere, California blackberry, Chesterberry, Cherokee blackberry, Cheyenne blackberry, common blackberry, coryberry, darrowberry, dewberry, Dirksen thornless berry, evergreen blackberry, Himalayaberry, hullberry, lavacaberry, loganberry, lowberry, Lucreliaberry, mammoth blackberry, marionberry, mora, mures deronce, nectarberry, Northern dewberry, olallieberry, Oregon evergreen berry, phenomenalberry, rangeberry, ravenberry, rossberry, Shawnee blackberry, Southern dewberry, tayberry, youngberry, zarzamora, and hybrids thereof.

In another embodiment, the tree nut plants are selected from the group consisting of almond, beech nut, Brazil nut, Brazilian pine, bunya, butternut, bur oak, Cajou nut, candlenut, cashew, chestnut, chinquapin, coconut, coquito nut, dika nut, gingko, Guiana chestnut, hazelnut (filbert), heartnut, hickory nut, Japanese horse-chestnut, macadamia nut, mongongo nut, monkey-pot, monkey puzzule nut, Okari nut, Pachira nut, peach palm nut, pecan, Pili nut, pistachio, Sapucaia nut, tropical almond, black walnut, English walnut, yellowhorn, and cultivars, varieties and hybrids thereof.

In a further embodiment, the cereal grains are selected from the group consisting of barley, buckwheat, pearl millet, proso millet, oats, corn, field corn, sweet corn, seed corn, popcorn, rice, rye, sorghum (milo), sorghum species, grain sorghum, sudangrass (seed), teosinte, triticale, wheat, wild rice, and cultivars, varieties and hybrids thereof. In a preferred embodiment, the cereal grain is selected from the group consisting of wheat, rice and corn. In a more preferred embodiment, the cereal grain is genetically modified corn.

In yet another embodiment, the grass forage, fodder and hay are selected from the group consisting of grasses that are members of the Gramineae family and those species included in the cereal grains group, pasture and range grasses, and grasses grown for hay or silage. In further embodiments, the Gramineae grasses may be green or cured.

In an embodiment, the non-grass animal feeds are selected from the group consisting of alfalfa, velvet bean, trifolium clover, melilotus clover, kudzu, lespedeza, lupin, sainfoin, trefoil, vetch, crown vetch, milk vetch, and cultivars, varieties and hybrids thereof.

In another embodiment, the herbs and spice plants are selected from the group consisting of allspice, angelica, anise, anise seed, star anise, annatto seed, balm, basil, borage, burnet, chamomile, caper buds, caraway, black caraway, cardamom, cassia bark, cassia buds, catnip, celery seed, chervil, chive, Chinese chive, cinnamon, clary, clove buds, coriander leaf, coriander seed, costmary, culantro leaves, culantro seed, cilantro leaves, cilantro seed, cumin, dillweed, dill seed, fennel, common fennel, Florence fennel seed, fenugreek, grains of paradise, horehound, hyssop, juniper berry, lavender, lemongrass, leaf lovage, seed lovage, mace, marigold, marjoram, mint, mustard seed, nasturtium, nutmeg, parsley, pennyroyal, black pepper, white pepper, poppy seed, rosemary, rue, saffron, sage, summer savory, winter savory, sweet bay, tansy, tarragon, thyme, vanilla, wintergreen, woodruff, wormwood, and cultivars, varieties and hybrids thereof. In a preferred embodiment, the mints are selected from the group consisting of spearmint, peppermint, and hybrids thereof.

In yet another embodiment, artichokes are selected from the group consisting of Chinese artichoke, Jerusalem artichoke, and cultivars, varieties and hybrids thereof.

In an embodiment, the tropical fruit plants are selected from the group consisting of anonna, avocado, fuzzy kiwifruit, hardy kiwifruit, banana, plantain, caimito, carambola (star fruit), guava, longan, sapodilla, papaya, passion fruit, mango, lychee, jackfruit, dragon fruit, mamey sapote, coconut cherimoya, canistrel, monstera, wax jambu, pomegranate, rambutan, pulasan, Pakistani mulberry, langsat, chempedak, durian, fig pineapple, jaboticaba, mountain apples, and cultivars, varieties and hybrids thereof.

In a further embodiment, the oil seed vegetable plants are selected from the group consisting of borage, calendula, castor oil plant, tallowtree, cottonseed, crambe, cuphea, echium, euphorbia, evening primrose, flax seed, gold of pleasure, hare's ear, mustard, jojoba, lesquerella, lunaria, meadowfoam, milkweed, niger seed, oil radish, poppy seed, rosehip, sesame, stokes aster, sweet rocket, tallowwood, tea oil plant, vermonia, canola, or oil rapeseed, safflower, sunflower, and cultivars, varieties and hybrids thereof.

### Examples

### Example 1—Strain Isolation and Testing for In Vitro Plant Growth Promotion Traits and Nitrogen Fixation

We isolated six Paenibacilli from arbuscular mycorrhizal fungal (“AMF”) spores, or the AMF associated grass rhizosphere on solid and semi-solid nitrogen free media as detailed in Table 1 below and utilizing methods as described in Liu X, Li Q, Li Y, Guan G, Chen S. Paenibacillus strains with nitrogen fixation and multiple beneficial properties for promoting plant growth. PeerJ. 2019 Sep. 23; 7:e7445. doi: 10.7717/peerj.7445. PMID: 31579563; PMCID: PMC6761918. We further confirmed the presence of the nfH gene utilizing methods described in Ando S., Goto M., Meunchang S., Thongra-ar P., Fujiwara T., Hayashi, H. and Yoneyama, T (2005) Detection of nifH Sequences in Sugarcane (Saccharum officinarum L.) and Pineapple (Ananas comosus [L.] Merr.), Soil Science and Plant Nutrition, 51:2, 303-308 and Gaby J C, Rishishwar L, Valderrama-Aguirre L C, Green S J, Valderrama-Aguirre A, Jordan I K, Kostka J E. Diazotroph Community Characterization via a High-Throughput nifH Amplicon Sequencing and Analysis Pipeline. Appl Environ Microbiol. 2018 Jan. 31; 84(4):e01512-17. Erratum in: Appl Environ Microbiol. 2019 May 16;85(11) and confirmed nitrogenase activity in vitro via the acetylene reduction assay, utilizing the methods described in Mus F, Khokhani D, MacIntyre A M, Rugoli E, Dixon R, Ané J M, Peters J W. Genetic Determinants of Ammonium Excretion in nifL Mutants of Azotobacter vinelandii. Appl Environ Microbiol. 2022 Mar. 22; 88(6):e0187621. The strains were tested for in vitro plant growth promoting abilities such as siderophore (utilizing the methods described in Schwyn B, Neilands J B. Universal chemical assay for the detection and determination of siderophores. Anal Biochem. 1987 January;160(1):47-56) and auxin production (utilizing the methods described in Gang S, Sharma S, Saraf M, Buck M, Schumacher J. Analysis of Indole-3-acetic Acid (IAA) Production in Klebsiella by LC-MS/MS and the Salkowski Method. Bio Protoc. 2019 May 5;9(9):e3230. doi: 10.21769/BioProtoc.3230), and phosphorus solubilization (utilizing the methods described in Chen Q, Liu S. Identification and Characterization of the Phosphate-Solubilizing Bacterium Pantoea sp. S32 in Reclamation Soil in Shanxi, China. Front Microbiol. 2019 Sep. 19; 10:2171. doi: 10.3389/fmicb.2019.02171). The genomes of these strains were sequenced, and we further confirmed the presence of full nif clusters and regulatory elements and the genomic capacity for siderophore and auxin production, as well as phosphorus solubility. Half of the strains have the genetically encoded ability to form siderophores, half of the strains produced auxin in vitro, and all the strains have the genomically encoded ability to solubilize phosphorus.

These strains form spores, making them good candidates for formulation, shelf-life stability, and environmental persistence. Further, they secrete ammonia (ammonia detection was achieved utilizing the methods described in Chaney, A. L. and Marbach, E. P. Modified Reagents for Determination of Urea and Ammonia. 1962. Clin Chem 8: 130-2) in vitro under N-free, low oxygen conditions, and they attach to and persist on corn roots in vitro for at least seven days. Results can be found in Table 1, below.

TABLE 1

| | | | | Phosphate | Phytate |
|---|---|---|---|---|---|
| VBTS | Species name | Siderophore | Auxin | solubilizer | solubilizer |
| 2584 | Paenibacillus | Positive | Positive | Positive | Positive |
| | peoriae | | | | |
| 2630 | Paenibacillus | Positive | Positive | Positive | Positive |
| | polymyxa | | | | |

| | ARA | Ammonia | Root | | |
|---|---|---|---|---|---|
| | activity | excretion | colonization | | |
| | (nmol/hr/ | (μM/ | (Log 10 | | |
| | Log10 | Log10 | CFU/g | | Location |
| VBTS | CFU/mL) | CFU/mL) | root) | Niche | Isolated |
| 2584 | 6.31 | 16.32 | 4.76 | Inside AMF | Walterboro, |
| | | | | spore from | SC |
| | | | | pasture | |
| 2630 | 0.70 | 21.53 | 3.87 | Inside AMF | Woodstock, |
| | | | | spore from | IL |
| | | | | corn field | |

### Example 2—Spore-Associated Bacteria Impact on AMF Root Colonization

Bacterial strains with and without AMF inoculum were evaluated in alfalfa for impact on root length colonization. Alfalfa seedlings were soil inoculated with 1 mL 1E7 CFU/mL bacteria and 300 spores of R. irregularis VBSF-268. Roots were harvested at 28 days, stained for fungal structures, and counted using the gridline intersect method. The bacterial strains did not negatively impact AMF colonization of alfalfa roots.

### Example 3—Plant Growth Promotion

Bacterial strains with and without AMF inoculum were evaluated in the greenhouse for plant growth promoting ability. Corn seeds (B73xMO17) were surface sterilized and sowed in one gallon pots containing a 3:1 sand:soil mixture, and inoculated with 50 mL 1E7 CFU/mL and/or 1000 spores of R. irregularis VBSF-268. Corn was grown for five weeks and fertilized once weekly with ½ strength low phosphorus Hoagland's solution (1×N, 20 uM P). At five weeks, height and shoot weight, fresh and dry, were measured. Additionally, shoots were evaluated for total phosphorus. Roots were harvested and stained for AMF colonization. See Table 2 and 3, below, for details.

TABLE 2

| | | Shoot Dry | | Phosphorus |
|---|---|---|---|---|
| | Shoot Dry | Weight % | Phosphorus | Uptake % |
| | Weight (g) | Change | Uptake (mg) | Change |
| Control | 5.7 | — | 5.5 | — |
| VBSF-268 | 5.8 | 1.8% | 7.9 | 43.6% |
| VBTS-2584 | 5.5 | −3.5% | 5.3 | −3.6% |
| VBTS-2630 | 6.8 | 19.3% | 6.6 | 20.0% |
| VBSF-268 | 6.7 | 21.8% | 8.1 | 53% |
| VBTS-2584 | | | | |
| VBSF-268 | 6.8 | 19.3% | 8.3 | 50.9% |
| VBTS-2630 | | | | |

TABLE 3

| | | Shoot Fresh | | |
|---|---|---|---|---|
| | Shoot Fresh | Weight % | Plant Height | Plant Height |
| | Weight (g) | Change | (cm) | % Change |
| Control | 51.9 | — | 27.7 | — |
| VBSF-268 | 53.5 | 3.1% | 29.3 | 5.8% |
| VBTS-2584 | 50.5 | −2.7% | 28.9 | 4.3% |
| VBTS-2630 | 59.4 | 14.5% | 31.0 | 11.9% |
| VBSF-268 | 59.2 | 17.2% | 30.2 | 9.0% |
| VBTS-2584 | | | | |
| VBSF-268 | 60.5 | 16.6% | 31.1 | 12.3% |
| VBTS-2630 | | | | |

As seen in Tables 2 and 3, above, N-fixing strains of bacteria in combination with AMF increased plant height and fresh and dry weight and total phosphorus in the plant more than bacterial strains or AMF alone or control. The bacterial strains did not negatively impact AMF colonization of corn roots.

### Example 4—Plant Growth Promotion Under Nitrogen Stress

Bacterial strains with and without AMF inoculum were evaluated in the greenhouse for plant growth promoting ability. Corn seeds (B73xMO17) were surface sterilized and sowed in one gallon pots containing a 3:1 sand:soil mixture, and inoculated with 50 mL 1E7 CFU/mL and/or 1000 spores of R. irregularis VBSF-271. Corn was grown for five weeks under nitrogen stress (i.e. a 50% reduction from required nitrogen content) and fertilized once weekly with ½ strength low phosphorus Hoagland's solution (1×N, 20 uM P). At five weeks, height and shoot weight, fresh and dry, were measured. Additionally, shoots were evaluated for total phosphorus. Roots were harvested and stained for AMF colonization. See Tables 4 and 5, below, for details.

TABLE 4

| 10 mM | | Shoot Dry | | Shoot Fresh | Plant | Plant |
|---|---|---|---|---|---|---|
| Nitrogen | Shoot Dry | Weight % | Shoot Fresh | Weight % | Height | Height % |
| Treatment | Weight (g) | Change | Weight (g) | Change | (cm) | Change |
| Control | 6.2 | — | 53.7 | — | 26.2 | — |
| VBSF-271 | 8.7 | 40.3% | 70.6 | 31.5% | 28.4 | 8.4% |
| VBTS-2584 | 7.0 | 12.9% | 59.9 | 11.5% | 27.3 | 4.2% |
| VBTS-2630 | 8.0 | 29.0% | 65.2 | 21.4% | 28.4 | 8.4% |
| VBSF-271 | 7.9 | 27.4% | 64.5 | 20.1% | 27.8 | 6.1% |
| VBTS-2584 | | | | | | |
| VBSF-271 | 8.9 | 43.5% | 70.8 | 31.8% | 28.1 | 7.3% |
| VBTS-2630 | | | | | | |

TABLE 5

| 5 mM | | Shoot Dry | | Shoot Fresh | Plant | Plant |
|---|---|---|---|---|---|---|
| Nitrogen | Shoot Dry | Weight % | Shoot Fresh | Weight % | Height | Height % |
| Treatment | Weight (g) | Change | Weight (g) | Change | (cm) | Change |
| Control | 6.6 | — | 53.4 | — | 24.9 | — |
| VBSF-271 | 7.2 | 9.1% | 55.5 | 3.9% | 25.7 | 3.2% |
| VBTS-2584 | 6.4 | −3.1% | 50.7 | −5.1% | 25.0 | 0.4% |
| VBTS-2630 | 7.4 | 12.1% | 57.2 | 7.1% | 25.7 | 3.2% |
| VBSF-271 | 7.2 | 9.1% | 55.7 | 4.3% | 25.9 | 4.0% |
| VBTS-2584 | | | | | | |
| VBSF-271 | 7.7 | 16.7% | 60.8 | 13.9% | 27.3 | 9.6% |
| VBTS-2630 | | | | | | |

As seen in Tables 4 and 5, above, N-fixing strains of bacteria in combination with AMF increased plant height and fresh and dry weight in the plant more than bacterial strains or AMF alone or control when under nitrogen stress. The bacterial strains did not negatively impact AMF colonization of corn roots.

### Example 5—(Prophetic) Nitrogen Reduction

Bacterial strains with and without AMF inoculum were evaluated in the greenhouse for plant growth promoting ability under different N fertilization regimes. Corn seeds (B73xMO17) were surface sterilized and sowed in one gallon pots containing a 3:1 sand:soil mixture, and inoculated with 50 mL 1E7 CFU/mL and/or 1000 spores of R. irregularis VBSF-268. Corn was grown for five weeks and fertilized once weekly with ½ strength low phosphorus Hoagland's solution (High N: 2×N, 20 uM P, Low N: 0.2×N, 20 uM P). At five weeks, shoots were measured, chlorophyll content was determined with a SPAD meter, and fresh and dry weights were collected. Additionally, shoots were evaluated for total N and P. Roots were harvested and stained for AMF colonization.

In the low N treatments, N-fixing strains of bacteria in combination with AMF increased plant fresh and dry weight and total phosphorus and nitrogen in the plant more than bacterial strains or AMF alone or UTC controls. The N fixing strains also rescued chlorophyll content in Low N treatments by 50%. The N fixing strains in combination with AMF increased nitrogen uptake efficiency in low N treatments by 25%.

### Example 6—(Prophetic) Plant Growth in the Field

Plant growth promoting abilities of Paenibacilli strains with and without MycoApply EndoPrime SC (EndoPrime SC is available from Mycorrhizal Applications) were evaluated in 2023 in four field studies in corn under two different rates of N fertilizer application (full application and 50% reduction) in split plots. NDVI (vigor), yield, and grain % N data were collected.

In the low N treatments, N-fixing strains of bacteria in combination with AMF increased yield and total nitrogen in the plant more than bacterial strains or AMF alone or UTC controls. The N fixing strains in combination with AMF increased nitrogen uptake efficiency in low N treatments by 15%

### Example 7—(Prophetic) 15N Method

15N is naturally more abundant in the soil than the air, so plants receiving nitrogen from biological nitrogen fixation will have lower 15N content. This number is usually very low. 15N dilution experiments artificially enrich the growth substrate to increase the amount of measurable 15N and statistical power and are used to quantify fixed nitrogen transfer to plants. 15N is stable, so samples can be dried and 15N quantified with isotope ratio mass spectrometry. This information was used to determine the amount of fixed N provided to a plant by a mixture of AMF and an N-fixing bacterium as compared to either alone.

The following bacterial strains were used in the study: wild-type Azotobacter vinelandii DJ, A. vinelandii strain AvFM16 (genotype: pcydAB opposite orientation as nifLA, phenotype: constitutive nitrogenase expression and ammonia secretion through disruption of nifL expression and upregulation of rnfl which helps with O2 tolerance), and Azotobacter vinelandii DJ nifD-(phenotype: N-fixation negative) (See Mus F, Khokhani D, MacIntyre A M, Rugoli E, Dixon R, Ané J M, Peters J W. Genetic Determinants of Ammonium Excretion in nifL Mutants of Azotobacter vinelandii. Appl Environ Microbiol. 2022 Mar. 22; 88(6) for strain information). A research strain of Rhizophagus irregularis was used for the AMF treatments. Sixteen treatments (15N labeled and unlabeled), each with six corn plants each and replicated three times in the greenhouse were applied as follows: Untreated control (UTC), AMF, nifD−, AMF+nifD−, AvFM16, AMF+AvFM16, WT DJ, AMF+WT DJ). We fertilized corn cultivar B73xMol7 twice weekly with ½ strength Hoaglands (a 1×N, 20 uM P solution, which incorporated labeled and unlabeled ammonium sulfate to 10% enrichment). The third youngest leaf (2×2 cm) was sampled at 5, 7, and 10 weeks post soil inoculation of bacteria and AMF. Leaves were ground and submitted to the Cornell Stable Isotope Analysis laboratory for isotope ratio mass spectrometry (IRMS). At ten weeks, shoots were measured, chlorophyll content was determined with a SPAD meter, and fresh and dry weights were collected.

The ratio of 15N to 14N in corn plants treated with N-fixing strains and AMF was reduced, indicating transfer of biologically fixed nitrogen to the plants. The N fixing strains in combination with AMF also increased nitrogen uptake efficiency in the full N treatments by 15% compared to UTC or AMF only controls.

What is claimed is:

1. An agricultural mixture comprising one or more diazotrophs and one or more arbuscular mycorrhizal fungi.

2. The mixture of claim 1, wherein the one or more diazatrophs are spore-associated bacteria.

3. The mixture of claim 2, wherein the one or more spore-associated bacteria are one or more Paenibacillus spp.

4. The mixture of claim 3, wherein the one or more Paenibacillus spp. are selected from the group consisting of Paenibacillus peoriae, Paenibacillus polymxya, Paenibacillus sonchi, and Paenibacillus azotifgiens.

5. The mixture of claim 3, wherein the one or more Paenibacillus spp. are selected from the group consisting of a biologically pure strain of Paenibacillus peoriae having all the identifying characteristics of Paenibacillus peoriae VBTS 2584 having ATCC accession number PTA-127852 and a biologically pure strain of Paenibacillus polymxya having all the identifying characteristics of Paenibacillus polymxya VBTS 2630 having ATCC accession number PTA-127851.

6. The mixture of claim 1, wherein the one or more arbuscular mycorrhizal fungi are selected from the group consisting of Glomus spp., Claroideoglomus spp., Funneliformis spp., Rhizophagus spp., Rhizopogon spp, Pisolithus spp, and Scleroderma spp.

7. The mixture of claim 6, wherein the one or more arbuscular mycorrhizal fungi are selected from the group consisting of Rhizophagus irregularis, Rhizophagus intraradices, Claroideoglomus etunicatum, Claroideoglomus claroideum, Funneliformis mosseae, Rhizopogon villosulus, Rhizopogon luteolus, Rhizopogon amylopogon, Rhizopogon fulvigleba, Pisolithus tinctorius, Scleroderma cepa, and Scleroderma citrinum.

8. A composition comprising one or more diazotrophs and one or more arbuscular mycorrhizal fungi and an agriculturally acceptable carrier.

9. The composition of claim 8, wherein the composition is a liquid or a solid.

10. The composition of claim 9, wherein the composition is a granule.

11. The composition of claim 10, wherein the granule comprises clay.

12. A method of improving plant growth comprising applying an effective amount of a mixture of claim 1 to a plant, plant propagation material or an area where a plant will grow.

13. A method of improving plant yield comprising applying an effective amount of a mixture of claim 1 to a plant, plant propagation material or an area where a plant will grow.

14. A method of improving plant quality comprising applying an effective amount of a mixture of claim 1 to a plant, plant propagation material or an area where a plant will grow.

15. A method of increasing nitrogen uptake by a plant comprising applying an effective amount of a mixture of claim 1 to a plant, plant propagation material or an area where a plant will grow.

16. A method of increasing ammonia concentration of soil comprising applying an effective amount of a mixture of claim 1 to the soil.
